(19) United States
(12) Patent Application Publication
(10) Pub. No.: US 2007/0069561 A1
(43) Pub. Date: Mar. 29, 2007

(54) Row of seats of a vehicle with an arm rest arranged between two outside seats

(76) Inventors: Jens Schnabel, Espelkamp (DE); Gunnar Erbe, Stemwede (DE)

Correspondence Address: SHLESINGER, ARKWRIGHT & GARVEY LLP, 1420 King Street, Suite 600, Alexandria, VA, 22314, US

(21) Appl. No.: 11/528,516

(22) Filed: Sep. 28, 2006

(30) Foreign Application Priority Data
Sep. 29, 2005 (DE) 10 2005 046 876.4

(51) Int. Cl. B60N 2/32; A47C 13/00; A47C 15/00

(52) U.S. Cl. 297/238; 297/113; 297/115; 297/118; 297/130

(57) ABSTRACT

Row of seats of a vehicle with an arm rest that is arranged between two outside seats and that can be folded into a position corresponding to the back rests of the adjacent seats for creating the back rest for an emergency seat including a head rest with a retaining part above the back rest, into which support rods of the head rest are inserted, and a contact part extending forwardly and downwardly from retaining part. Back rest of the emergency seat is lockable. Additional locking apparatus for the back rest of the emergency seat is provided without use of additional components. Head rest is height-adjustably guided on a frame laterally extending inwardly into region of arm rest of one of adjacent seats. In retracted position of head rest, contact part of head rest overlaps free end of upwardly folded arm rest.

### CROSS-RELATED APPLICATIONS

This application claims priority of German Application no. 2005 046 876.4, filed Sep. 29, 2005, which is incorporated herein by reference.

### FIELD OF THE INVENTION

The invention relates to a row of seats of a vehicle with an arm rest arranged between two outside seats. More particularly, the invention relates to a row of seats of a vehicle with an arm rest arranged between two outside seats, and which can be folded into a position corresponding to the back rests of the adjacent seats in order to create the back rest for an emergency seat.

### BACKGROUND OF THE INVENTION

A row of seats of this kind is described in DE 695 15 264 T2. It includes two complete outside seats and an emergency seat arranged between the two former, and the back rest of the emergency seat can be an upwardly foldable arm rest that is provided for the two outside seats. To this end, the arm rest can be folded around a lower transverse axis, either downward into its arm rest position or rearward into its back rest position. The transverse axis is arranged on an auxiliary frame, which forms the back cover of the arm rest. Just like the back rest, the auxiliary frame can be folded downward thereby opening a pass-through load opening toward a load compartment. The frame carries a height-adjustable head rest and can be locked at its upper end in its upright position to a cross bar that is immovably fixed to the chassis or to a cross bar of the adjacent seats, in which position it closes the pass-through load opening.

Three different states of use can be achieved with the apparatus described above. In a first state of use both the arm rest as well as the auxiliary frame are folded back into the plane of the back rests of the two adjacent seats. In this state the arm rest serves as a back rest for the emergency seat allowing three passengers to sit on the seat bench and providing each person on each seat with a separate height-adjustable head rest. In the second state of use the auxiliary frame stays locked on the cross bar and the arm rest is folded down separately. Only the two outside seats for which the folded-down arm rest is provided can be occupied by passengers in this state. In the third state of use, the locking of the auxiliary frame is released, whereby the auxiliary frame along with the arm rest can be folded down, which allows for a lengthier object to be loaded back-to-front through the pass-through load opening that becomes correspondingly accessible from the trunk and/or luggage compartment.

### OBJECTS AND SUMMARY OF THE INVENTION

It is an object of the present invention to overcome the drawbacks of the prior art.

It is an object of the present invention to provide a row of seats of this kind with an additional locking device for the back rest of the emergency seat without the use of additional components.

The object is achieved according to the invention with a row of seats of a vehicle, including two outside seats. An arm rest arranged between the two outside seats, the armrest having a free end and being foldable into a position corresponding to a back rest of adjacent outside seats in order to create the back rest for an emergency seat. The emergency seat including a head rest with a retaining part arranged substantially above a top of the back rest, and into which support rods of the head rest are inserted, and the head rest including a contact part that extends forwardly and downwardly from the retaining part. The back rest of the emergency seat is lockable in its state of use. The head rest being height-adjustably guided in a frame from a retracted position to an extended position, the frame extending laterally into the region and is part of the arm rest of at least one of the adjacent seats, and in the retracted position of the head rest, the contact part of the head rest overlapping the free end of the upwardly foldable arm rest.

The present invention takes advantage of the shape of a so-called “comma-shaped head rest” for locking the back rest of an emergency seat, in particular in that the contact part, which extends from the retaining part of the head rest toward the front and down, acts like a locking device, when the head rest is retracted, resting from the front against the back rest. Since the head rest is designed to absorb strong forces, it provides stable locking action of the back rest of the emergency seat. This locking action is effected without the use of additional components because in this instance the head rest, that is necessary for the emergency seat in any case, is used to achieve the locking action.

Further advantageous configurations of the invention are as set forth herein.

The invention will subsequently be illustrated in more detail using the embodied examples.

Relative terms such as left, right, up, and down, are for convenience only and are not intended to be limiting.

### BRIEF DESCRIPTION OF THE DRAWINGS

FIGS. 1 to 3 show a schematic perspective view of a so-called 60% back rest part of a back row of seats of a vehicle in accordance with a first embodiment of the invention in three different states of use; and

FIGS. 4 and 5 show a schematic perspective view of a 60% back rest part in accordance with a second embodiment of the invention in two different states of use.

### DETAILED DESCRIPTION OF THE INVENTION

The 60% back rest part 1 that is represented in the drawing is completed to a full-length back rest of a back seat bench by another 40% back rest part, not shown here. 60% back rest part 1 includes 40% back seat support part 2 that is assigned to a complete outside seat and a 20% back rest part 3 that is part of the emergency seat which is arranged between the two outside seats. 60% back rest part 1 may have a uniform frame 4 with a panel-type back wall 4.1 that carries and supports all other of its components. Frame 4 is locked on an upholstered component 5 that is secured to the chassis, whereby this component is simultaneously configured as a side face of the outside seat. On the top of component 5 a handle 6 is provided for unlocking 60% back rest part 1, only partially indicated here. After it has been unlocked, 60% back rest part 1, in its entirety, can be folded forward around a bottom pivot axis, not shown here, whereby the load area of a trunk or luggage compartment that is arranged behind the row of seats is enlarged.

The upholstered part of 40% back rest part 2 includes a back lean-back rest 7 and a shoulder lean-back rest 8. Two guide tubes 9 run into the top of shoulder lean-back part 8 that serve for the height-adjustable receiving of two support rods of a head rest, not shown here.

20% back rest part 3 of the emergency seat includes a bottom upholstery part 10 and an arm rest 11. It is completed by a comma-shaped head rest 12. The head rest 12 has a retaining part 12.1, which is arranged over the top side of the back rest, as well as a contact part 12.2, that extends from retaining part 12.1 toward the front and the bottom. Two support bars 13 run into retaining part 12.1; they retain head rest 12. Only one of these support rods 13 is visible in the drawing. In frame 4 of 60% back rest part 1 the two support rods 13 are height-adjustably guided. Corresponding guide tubes 14 are arranged in frame 4 for this purpose.

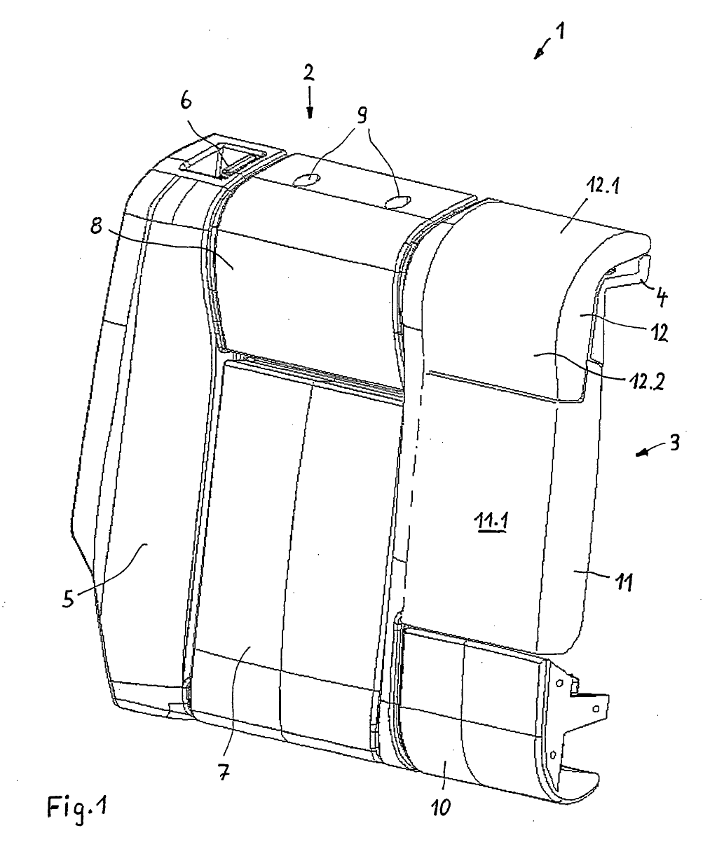

In the embodiment according to FIGS. 1 to 3 back wall 4.1 of frame 4 has a cutout 15 in the area of 20% back rest part 3 that is completely filled, i.e. closed, by the arm rest when arm rest 11 is folded upward.

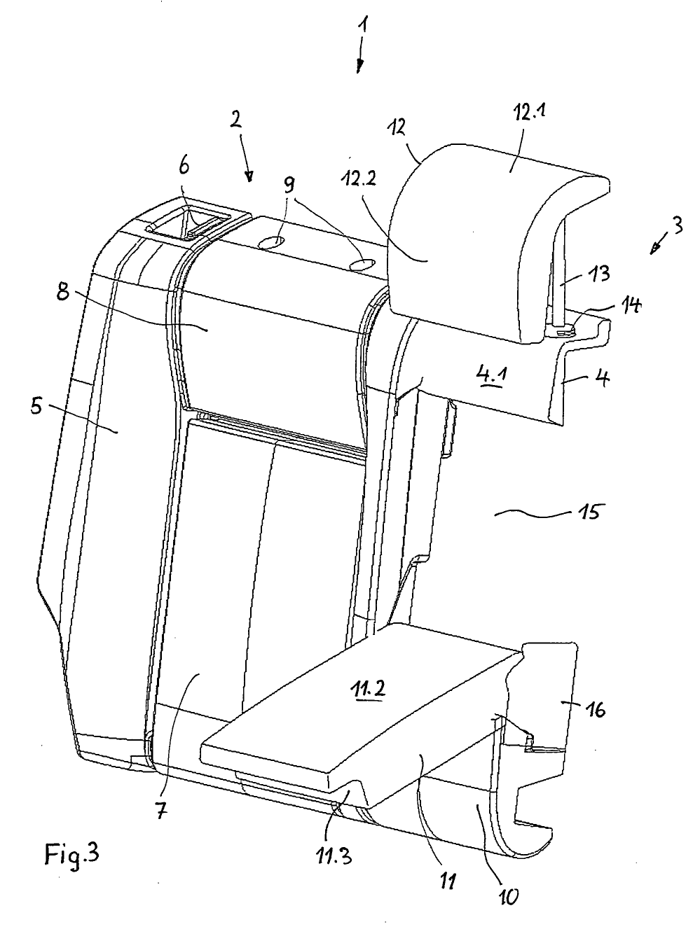

Arm rest 11 is arranged with the ability to pivot around a bottom pivot axis, not visible here, which is configured on end shields 16 of frame 4. Shown is only one of the two end shields, specifically only in FIG. 3.

Three states of use can be achieved with the back rest arrangement as described above. In a first state of use, as depicted in FIG. 1, arm rest 11 is folded up around its pivot axis. In this state bottom side 11.1 of arm rest 11 becomes the lean-back area of 20% back rest part 3 while top side 11.2 of arm rest 11 closes cutout 15 in back wall 4.1 of 60% back rest part 1.

In the folded-up state arm rest 11 rests against a stop, not shown here, which prevents, on the one hand, that arm rest 11 can be pivoted through into the luggage compartment and ensures, on the other hand, that cutout 15 is closed flush by arm rest 11. Moreover, another stop, not shown here, that is commonly known to those skilled in the art, is provided which retains arm rest 11 in its upright position and that can be released by a slight pull on the free end of arm rest 11.

In addition to the above stop, head rest 12 is also utilized for locking arm rest 11 when the arm rest 11 is in its upright position. To be able to carry out this locking function it is necessary for support bars 13 of head rest 12 to be completely inserted into guide tubes 14 of frame 4. In this state the bottom area of contact part 12.2 of head rest 12 overlaps the free end of arm rest 11. In the area of overlap with the head rest 12 the arm rest 11 features a complementary recess 11.3 relative to the bottom area of contact part 12.2, whereby the front side of contact part 12.2 transitions flush into bottom side 11.1 of arm rest 11 and/or the contact surface of 20% back rest part 3. The state of use as described above according to FIG. 1 is selected when the emergency seat is vacant, when no arm rest 11 is needed for the outside seats and when no lengthy items are to be loaded back-to-front from the luggage compartment.

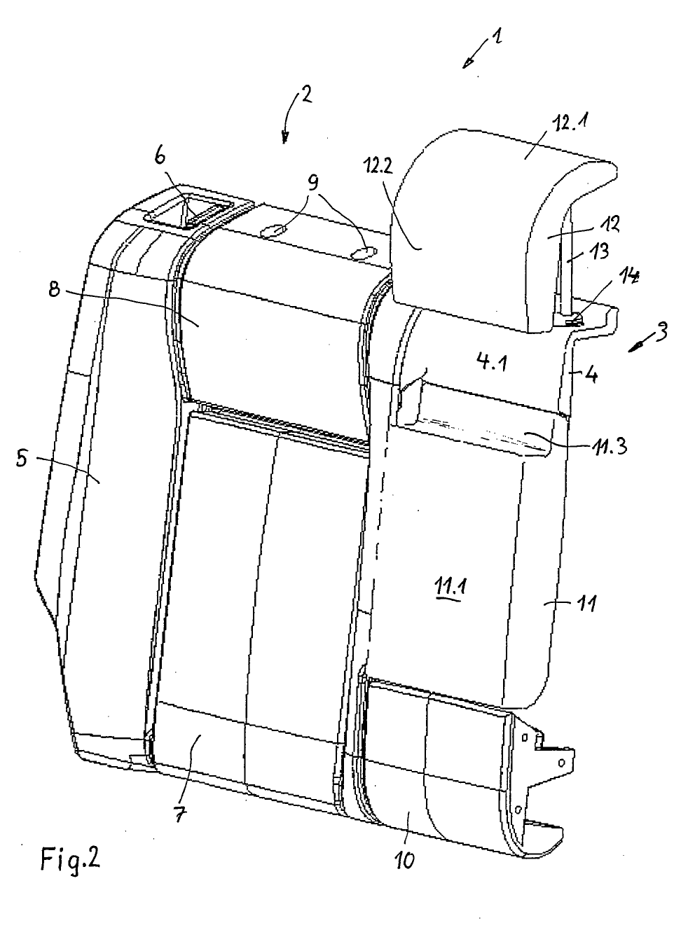

The state of use as shown in FIG. 2 is different from the state described previously in that head rest 12 is extended upward which results in the release of additional locking device of arm rest 11. This state of use is selected when the emergency seat is to be occupied by a passenger.

The state of use as shown in FIG. 3 allows for back-to-front loading of longer-dimensioned items from the luggage compartment through cutout 15. In this state arm rest 11 is folded down, thereby opening cutout 15. To achieve this state head rest 12 must be extended upward in order to release arm rest 11 from its locked state. After arm rest 11 has been folded down it is also possible, naturally, to return head rest 12 to its previous position helping the driver to have better visibility toward the back.

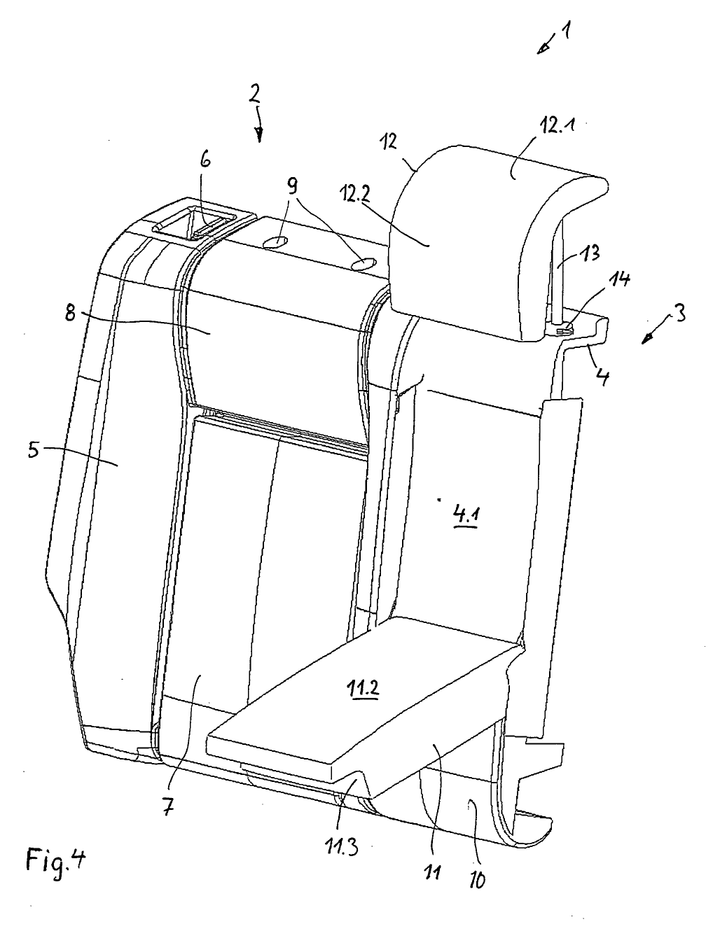

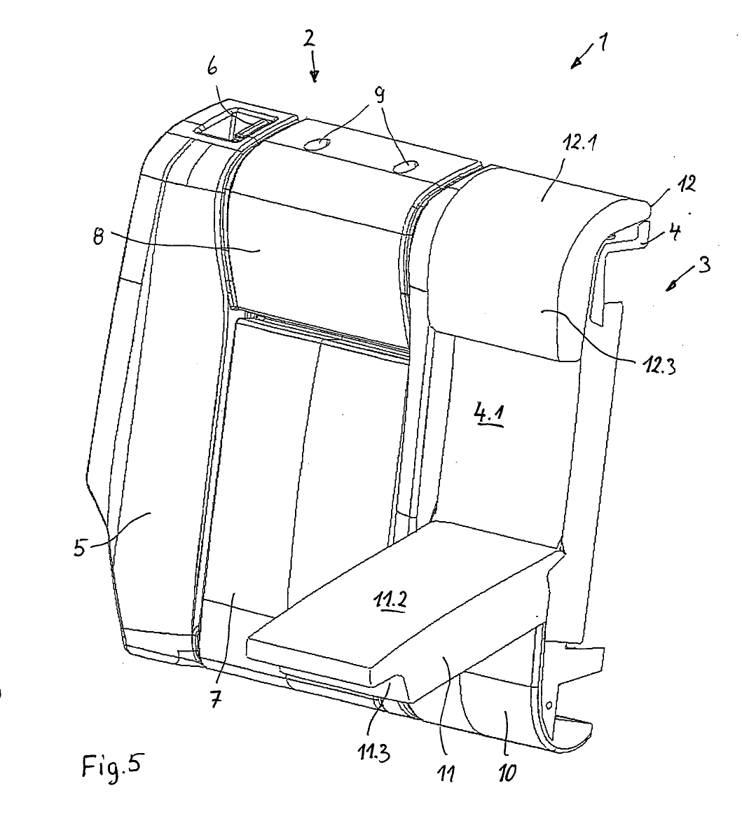

FIGS. 4 and 5 represent a further embodiment that is different from the previous example in that back wall 4.1 of frame 4 of 60% back rest part 1 is not cut out in the area of arm rest 11, which means it is also closed in that area. Otherwise this example corresponds to the previous example, in particular with regard to the function of head rest 12 of the emergency seat in terms of an additional locking action for arm rest 11.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Row of seats of a vehicle, comprising:
a) two outside seats;
b) an arm rest arranged between the two outside seats, the armrest having a free end and being foldable into a position corresponding to a back rest of adjacent outside seats in order to create the back rest for an emergency seat;
c) the emergency seat including a head rest with a retaining part arranged substantially above a top of the back rest, and into which support rods of the head rest are inserted, and the head rest including a contact part that extends forwardly and downwardly from the retaining part;
d) the back rest of the emergency seat being lockable in its state of use;
e) the head rest being height-adjustably guided in a frame from a retracted position to an extended position, the frame extending laterally into the region of the arm rest and is part of at least one of the adjacent seats; and
f) in the retracted position of the head rest, the contact part of the head rest overlapping the free end of the upwardly foldable arm rest in its upwardly folded position, in use.

2. Row of seats as claimed in claim 1, wherein:
a) the arm rest includes a recess at its free end for the complementary receiving of a bottom area of the contact part of the head rest when in a locked state.

3. Row of seats as claimed in claim 2, wherein:
a) a back wall of the frame includes a cutout in a region of the arm rest that is closed by the arm rest when the arm rest is in its upwardly folded position; and
b) the back wall serves as a back-to-front load opening for lengthy items from a luggage compartment when arm rest is in its downwardly folded position, in use.

4. Row of seats as claimed in claim 1, wherein:
a) a back wall of the frame includes a cutout in a region of the arm rest that is closed by the arm rest when the arm rest is in its upwardly folded position; and
b) the back wall serves as a back-to-front load opening for lengthy items from a luggage compartment when the arm rest is in its downwardly folded position, in use.
